(19) United States
(12) Patent Application Publication
(10) Pub. No.: US 2002/0165840 A1
(43) Pub. Date: Nov. 7, 2002

(54) Decision matrix-a pattern generation and recognition system for decision support

(76) Inventor: Randy Jonas Frid, Scottsdale, AZ (US)

Correspondence Address: RANDY JONAS FRID, 11132 EAST BECKER LANE, SCOTTSDALE, AZ, 85259, US

(21) Appl. No.: 09/681,582

(22) Filed: May 2, 2001

(51) Int. Cl. G06N 5/00; G06F 17/00

(52) U.S. Cl. 706/45

(57) ABSTRACT

Herein is disclosed a pattern generation and recognition system for use in decision support systems comprising six Discrete Components, bound together by a plurality of weighted direct, indirect and spanning relationships that form a Decision Matrix node. A plurality of Decision Matrix nodes, bound by the same relationships then aggregate into a Decision Matrix. Each Decision Matrix, Decision Matrix node and Discrete Component maintain the ability to participate in a plurality of Decision Matrix's, Decision Matrix nodes and Discreet Components, thus allowing the for modular expansion and contraction of a Decision Matrix to unlimited size and complexity utilizing the Decision Matrix form and structure of patterns.

### BACKGROUND OF INVENTION

The human mind is only capable of performing one task: Pattern Generation and Recognition. From prenatal to early childhood the human brain is making and breaking synaptic connections in response to sensory input. With each repetition the connections between synapses strengthens until becoming permanent. In the early stages of development, if a particular sensory input illustrates a single condition, synapses may join temporarily in response to formulate a simple pattern. If the condition is not repeated then the synapses will break and be used within another pattern based on some other input. If the condition is repeated in a given timeframe the synaptic connections are further strengthened. With repetition the connections will become permanent, “hard wiring” the brain much like today's computer hardware.

Between ages 3 to 6 the synapses have finished hardwiring and we have developed a system for performing pattern recognition based on soft connections (software) that allow us to manipulate our hardwired templates in a virtual fashion (similar to logic gates) and perform calculations to render “virtual” patterns and store them for future use as virtual connections between primary templates. This is the primary reason why early education, exposure to parental, cultural and environmental sensory input hardwires our children with certain dispositions. Compensation patterns for deficiencies introduced during this process must be overcome in later years using virtual patterns, which are much harder to create and manage. It's these patterns that allow us to negotiate through trillions of bits of parallel information and recognize components that don't match the pattern (such as the nickel that catches your eye, laying in the ditch when you're walking down the street). Our brains would be totally overwhelmed if we did not have some way of providing a preliminary filtration system. Every time our temperature rises we match a pattern and make adjustments to other bodily subsystems (condition/response). Every time we speak we assemble the sounds and match them to pre-developed patterns to understand the intent of the speech.

The list of pattern requirements seems endless, and it's because the list seems endless that it becomes obvious that, with limited brain matter to work with, we must have a way to re-use patterns in multiple instances, each instance maintaining its own state information, and that the relationship between these patterns must be adjusted for context and relative value. Without such a system our mind would super-saturate in no time at all. Experience derives from stored patterns. Intuition is the recognition of new relationships between patterns and the strength of the relationships. You may feel that patterns can be of any size and complexity but if you look at the problems this raises you can see there must be form and structure to our analysis or we would become overwhelmed managing the pattern generation system as a separate process altogether. A structured system also provides the optimum throughput although it also automatically implies boundaries to our capabilities. All of this leads us to draw certain conclusions: 1. There must be a system behind pattern generation. 2. The system must be finite to be manageable. 3. The relationships between patterns must be analog to allow weighting. 4. The system must employ re-entrant (feedback) algorithms to facilitate evolution. 5. The system must enable storage of multiple state information.

The Decision Matrix addresses a general problem, that inexperienced people are weaker at making decisions than experienced people and that if we could develop a way to capture experienced peoples best practices in a formal structure, then inexperienced people could query the structure to test their decisions against patterns that had been previously established by more experienced people or systems and could include information and/or questions that could contain rules, thresholds and triggers. Historically, rule based systems have been limited in capability because of the enormity of information and questions, and the fact that the same information or question may have completely different meaning if viewed in a different context. With the variables being almost unlimited as well as the interpretations also seeming unlimited, the ability to build a viable rule based system with today's technology, that could handle the vast number of decisions humans can make, with all the permutation of circumstance, would likely be impossible. The Decision Matrix provides a multi-dimensional pattern generation system more attuned to the way we think as humans by providing the necessary form and structure to massively reduce redundancy in information and questions by providing a unique framework of interrelationships between information and/or questions. With this invention it will be possible to build advanced teaching aids for children and adults alike. The Decision Matrix can penetrate into every aspect of human existence to bring help to those who need assistance in making decisions by guiding them along tested paths and by helping them avoid potential pitfalls made by others. The application of the Decision Matrix in society, commerce, government and many other sectors, offers many positive possibilities.

### SUMMARY OF INVENTION

The Decision Matrix is a pattern generation and recognition system for decision support. The Decision Matrix provides a specific form and structure for problem solving that eliminates redundant information and/or questions by encapsulating the information and/or questions within a multi-dimensional lattice structure. If the Decision Matrix is utilized within a software application then users could navigate through information and questions in a configurable multi-dimensional way. This makes the Decision Matrix a revolutionary learning and research tool as it captures knowledge and expertise from experienced people and systems as information, questions, rules, thresholds and triggers that helps guide less experienced people and systems through complex decision processes.

The Decision Matrix can be applied in any aspect of human society as any subject matter expert can expand the overall Decision Matrix structure in any field of expertise required. The ability for a Decision Matrix and its integral Decision Matrix nodes and Discreet Components to maintain multiple states, means that any single piece of information and/or question embodied within a Decision Matrix, Decision Matrix node or Discreet Component can be presented in many different interpretations and each interpretation is dependent upon the individual state. This process eliminates tremendous redundancy from the way we search and represent information today while also adding structure to navigation throughout a decision cycle.

### BRIEF DESCRIPTION OF DRAWINGS

Drawing 1 demonstrates the detailed composition of a Decision Matrix Node 4 that comprises six Discreet Components A₁, A₂, B₁, B₂, C₁, C₂ of information with, direct 1, indirect 2 and spanning 3 relationships between them. Direct relationships 1 are indicated by the solid connections, indirect relationships 2 are indicated by the dotted lines, and spanning relationships 3 are indicated by the bracket lines. Relationship weights are analog in nature with possible weights ranging from zero point zero (0.0) meaning no relationship, to one point zero (1.0) meaning a guaranteed relationship. Ranges between 0.0 and 1.0 indicate the level of confidence in the relationship.

Drawing 2 demonstrates how individual Decision Matrix Nodes 4 are aggregated together to form a Decision Matrix 5.

Drawing 3 demonstrates how Discreet Components A₁, A₂, B₁, B₂, C₁, C₂, and/or an entire Decision Matrix Node 4, and/or an entire Decision Matrix 5 can participate in a plurality of different Decision Matrix's, Decision Matrix nodes or Discreet Components so that interrelationships 6, 7, 8, 9, 1 0 between a plurality of each allows unlimited growth with minimum redundancy.

### DETAILED DESCRIPTION

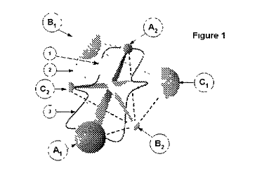

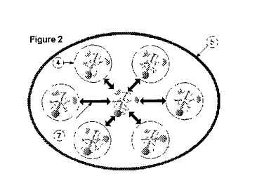

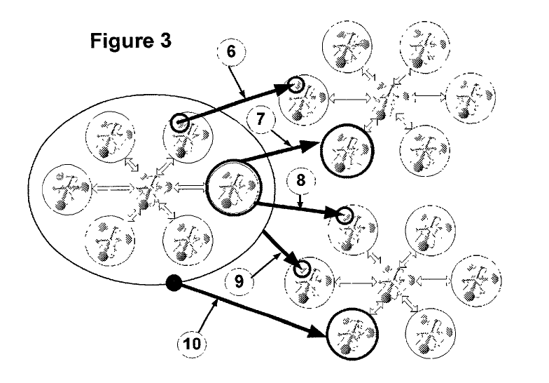

A Decision Matrix Node 4 is the clustering of six Discrete Components A₁, A₂, B₁, B₂, C₁, C₂, bound by direct 1, indirect 2 and spanning 3 relationships as shown in FIG. 1. In turn, Each Discrete Component, or the entire Decision Matrix Node itself, can participate in a plurality of additional Discrete Components and/or Decision Matrix Nodes. The ability for Discrete Components or entire Decision Matrix nodes being able to participate in a plurality of Decision Matrix nodes allows for the multi-dimensional growth of the Decision Matrix as depicted in FIG. 3. A Decision Matrix node and/or Discrete Component can then aggregate into a Decision Matrix which in turn also has the ability to participate in a plurality of other Decision Matrix's, Decision Matrix nodes and/or Discrete Components.

The Decision Matrix is broken into four distinct parts. The first fundamental part of the Decision Matrix includes Decision Matrix Nodes 4 and their six integral Discreet Components A₁, A₂, B₁, B₂, C₁, C₂, as depicted in Drawing 1. Each discrete component represents a single piece of information and/or a single associated question.

The second part of the Decision Matrix defines the relationships 1, 2, 3 between the Discreet Components and nature of these relationships. The relationships are defined as Direct 1, Indirect 2 and Spanning 3 relationships. Drawing 1 demonstrates direct 1 relationships as indicated by the solid connections between Discreet Components, indirect 2 relationships are indicated by the dotted lines, and spanning 3 relationships are indicated by the bracket lines.

The third part of the Decision Matrix defines the nature of each relationship 1, 2 and 3 as an associated relevancy weight that indicates the level of confidence in the nature of the relationship as a measurement between 0.0 and 1.0. A weight of 0.0 would indicate that no relationship exists in this instance, whereas a weight of 1.0 would indicate a guaranteed relationship in each instance. Any weight score that lies between 0.0 and 1.0 would indicate a confidence level ranging from very weak to very strong. These associated weights are adjustable to permit the strengthening or weakening of relationships and to permit learning and evolution within the Decision Matrix Node and/or Decision Matrix.

The fourth part, the Decision Matrix 5, is defined as the aggregation of any combination of six Decision Matrix nodes 4 and/or Discrete Components into a combined Decision Matrix 5 bound by direct 1, indirect 2, and spanning 3 relationships with associated weights between 0.0 and 1.0. Each of the six Discreet Components A₁, A₂, B₁, B₂, C₁, C₂, each Decision Matrix node 4 and each Decision Matrix 5 can connect to, and participate in, a plurality of Decision Matrix's, Decision Matrix nodes or other Discrete Components. This functionality allows the growth of a multi-dimensional structure. In this way each Discrete Component, each Decision Matrix node and each Decision Matrix can take on a different meaning (state) and relationship weight depending on which Discrete Component, Decision Matrix node or Decision Matrix it is currently participating in.

With the capability of a Discrete Component and/or Decision Matrix node and/or Decision Matrix being able to participate in a plurality of Discrete Components, Decision Matrix nodes and/or Decision Matrix's, the functionality now exists to create different patterns by multitasking a combination of these existing parts.

When a Discrete Component, Decision Matrix node or Decision Matrix exists and participates in a plurality 6, 7, 8, 9, 1 0 of Discrete Components, Decision Matrix nodes or Decision Matrix's, then its embodied information and/or question may take on a different meaning and weighted value for each individual instance, but it will not change the fundamental structure of the embodied information and/or question. As an example, a Discrete Component may embody a piece of information in the form of a word such as “Exchange”. To one Decision Matrix node this information may be interpreted to mean “to give something and get something back”, yet in another Decision Matrix node this same information may integrate into the phrase “stock exchange”, and to another it may become “railway exchange”, and to yet another may aggregate into “currency exchange”, and to a final Decision Matrix node it may become “Microsoft © Exchange”. As you can see, the information “Exchange” remains static, yet its interpretations may be many. I define this functionality as having the ability to store multiple states, which then allows each Discrete Component, Decision Matrix node or Decision Matrix to participate in a plurality of Discrete Components, Decision Matrix nodes or Decision Matrix's.

Discrete Component, Decision Matrix node and Decision Matrix relationship weights 1,2,3 are calculated as follows (where W=“Initial Weight” prior to adjustments):

A1=A2(W=1.0)+B1(W=0.4)+B2(W=0.4)

A2=A1(W=1.0)+B1(W=0.4)+B2(W=0.4)

B1=A1(W=0.4)+A2(W=0.4)+B2(W=1.0)+C1(W=0.4)+C2(W=0.4)

B2=A1(W=0.4)+A2(W=0.4)+B1(W=1.0)+C1(W=0.4)+C2(W=0.4)

C1=B1(W=0.4)+B2(W=0.4)+C2(W=1.0)+Span(W=0.8)

C2=B1(W=0.4)+B2(W=0.4)+C1(W=1.0)+Span(W=0.8)

Relationship 1, 2, 3 weights have the ability to diminish or increase in value in relation to external influence and/or time and/or inactivity. This methodology allows for transient instances ( connections only used once or infrequently ) to decompose or be strengthened depending on the level of confidence in the relationship.

1. What I claim as my invention is a pattern generation and recognition system for use in decision support systems that is comprised of six discreet components A ₁, A₂, B₁, B₂, C₁, C₂, bound together by a plurality of direct 1, indirect 2 and spanning 3 relationships to form a decision matrix node 4:

2. A method by which six Decision Matrix Nodes 4 according to claim 1 aggregate by utilizing a plurality of direct 1, indirect 2 and spanning 3 relationships to form a Decision Matrix 5.

3. A method by which a Discreet Component A₁, A₂, B₁, B₂, C₁, C₂, or a Decision Matrix Node 4 or a Decision Matrix 5 according to claims 1 and 2 may participate in a plurality of Discreet Components, Decision Matrix Nodes or Decision Matrix's.

4. A method by which each relationship according to claim 1 and 2 has an associated adjustable weighted value.

5. A method by which a Decision Matrix according to claim 4 employs relationship weights that diminish or increase in weight value in relation to external influence and/or time and/or inactivity.

6. A method by which a Decision Matrix and/or Decision Matrix node and/or Discreet Component A₁, A₂, B₁, B₂, C₁, C₂ according to claim 1 and 2 employs a re-entrant (learning feedback) algorithm used to train the Decision Matrix 5 and/or Decision Matrix node 4 and/or Discreet Component A₁, A₂, B₁, B₂, C₁, C₂ by modifying relationship weights 1,2,3 and/or the embodied data and/or questions.

7. A method by which a Discreet Component A₁, A₂, B₁, B₂, C₁, C₂, according to claim 1 contains a single embodiment of information and/or a single question.

8. A method by which a Discreet Component A₁, A₂, B₁, B₂, C₁, C₂, or a Decision Matrix Node 4 or a Decision Matrix 5 according to claim 1, 2 and 3 employs the ability to maintain a plurality of states.
